(19) United States
(12) Patent Application Publication
(10) Pub. No.: US 2004/0124910 A1
(43) Pub. Date: Jul. 1, 2004

(54) Automatic adjustment system for source current and sink current mismatch

(75) Inventors: Chao-Hsi Chuang, Shinying City (TW); Yu-Hua Liu, Hsinchu (TW)

Correspondence Address: Richard P. Berg, Esq., c/o LADAS & PARRY, Suite 2100, 5670 Wilshire Boulevard, Los Angeles, CA, 90036-5679, US

(73) Assignee: Airoha Technology Corp.

(21) Appl. No.: 10/727,972

(22) Filed: Dec. 3, 2003

(30) Foreign Application Priority Data
Dec. 6, 2002 (TW) 91135407

(51) Int. Cl. H02J 1/10

(52) U.S. Cl. 327/541

(57) ABSTRACT

An automatic adjustment system for source current and sink current mismatch. The system includes a startup compensation/setup device to perform initialization current compensation and accordingly implement a control reference table, a determination device to output a control signal according to the control reference table, and a current compensation device to switch corresponding internal switches on and off according to the control signal and complete the desired compensation for source current and sink current mismatch.

### BACKGROUND OF THE INVENTION

1. Field of the Invention

The invention relates to an automatic adjustment system for source current and sink current mismatch, which implements a control reference table, such that a determination device and a current compensation device accordingly perform desired compensation for source current and sink current mismatch.

2. Description of the Related Art

In a typical transceiver IC for communication, a phase locked loop (PLL) synthesizer is widely used. As shown in FIG. 1, the PLL synthesizer essentially includes a reference oscillator 10 and a reference divider 11 to provide a reference frequency Fref; a voltage-controlled oscillator 14 and a main divider 13 to provide a main frequency Fmain; a phase detector 12 and a loop filter 15 to produce a feedback frequency Fback by comparing the reference and main frequencies and output the feedback frequency Fback to the oscillator 14 to further produce an operating frequency Fout to be output.

However, as cited, the PLL synthesizer has some problems such as phase noises, non-linear effects, reference spurs and the like. One source of problems is source current flowing to the loop filter 15 being mismatched to sink current flowing from the filter 15. Therefore, a desired charge pump circuit is needed to overcome the current mismatch problem.

### SUMMARY OF THE INVENTION

It is an object of the present invention to provide an automatic adjustment system for source current and sink current mismatch, which automatically adjusts source current and sink current mismatch to reduce phase noise.

The present invention is generally directed to an automatic adjustment system for source current and sink current mismatch, which automatically adjusts source current and sink current mismatch to reduce spurs. The system includes a startup compensation/setup device to perform initialization current compensation and accordingly to implement a control reference table, a determination device to output a control signal according to the control reference table, and a current compensation device to switch corresponding internal switches on and off according to the control signal and complete the desired compensation for source current and sink current mismatch.

### DESCRIPTION OF THE DRAWINGS

The present invention will be described by way of exemplary embodiments, but not limitations, illustrated in the accompanying drawings in which like references denote similar elements, and in which:

FIG. 1 is a block diagram of a typical PLL synthesizer;

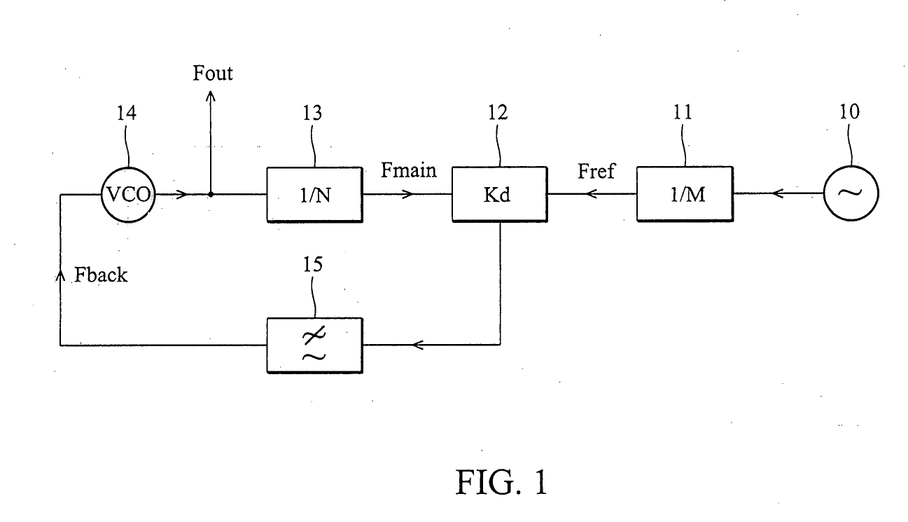

FIG. 2 is a block diagram of an automatic adjustment system according to the invention;

FIG. 3 is a schematic diagram of the interior of a current compensation device of FIG. 2 according to the invention;

FIG. 4 is a schematic diagram of the interior of a startup compensation/setup device of FIG. 2 according to the invention; and

FIG. 5 is a schematic diagram of the interior of a determination device of FIG. 2 according to the invention.

### DETAILED DESCRIPTION OF THE INVENTION

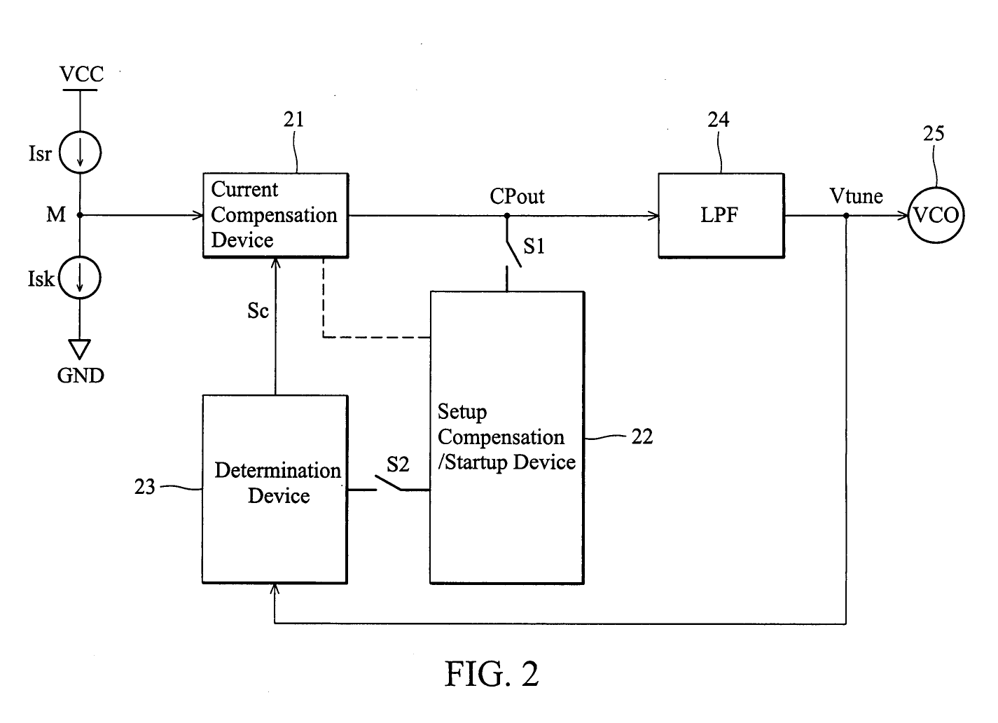

FIG. 2 is a block diagram of an automatic adjustment system according to the invention. In FIG. 2, the system essentially includes a startup compensation compensation/setup device 22, a determination device 23 and a current compensation device 21. A switch S1 is implemented between the devices 21 and 22 for connection and another switch S2 is implemented between the devices 22 and 23 for connection.

As shown in FIG. 2, when the system is provided with an external voltage VCC, on the feature difference between P-type and N-type semiconductor devices, a constant current, namely source current Isr, is generated between the voltage VCC and a middle point M, and another constant current, namely sink current Isk, is generated between the middle point M and a grounding terminal GND. Generally, the two currents Isr and Isk are the same and balance, such that a stable operating current and voltage are provided to the subsequent low pass filter (LPF) 24 and voltage-controlled oscillator 25 for use. However, due to communication specification requirements of heat, phase margin and the like, the source and sink currents Isr and Isk are physically not the same. At startup, the switch S1 is closed to turn on the device 22 for startup compensation. The startup compensation can be performed directly through the control device 21 itself (dotted line) or indirectly through the device 23 to output a control signal Sc for controlling the device 21 after the switch S2 is closed (solid line). After the startup compensation is completed, the device 22 sets up a reference index to generate a logic control table. As soon as the logic control table is completed, the switch S1 is opened to protect the system from the startup compensation again, affecting the entire operation.

As shown in FIG. 2, when a mismatch between the currents Isr and Isk occurs, the device 23 outputs a logical control signal to the device 21 according to the logic control table. The device 21 then performs current adjustment according to the logical control signal, accordingly achieving the automatic adjustment. Interiors for the devices are further described in the following.

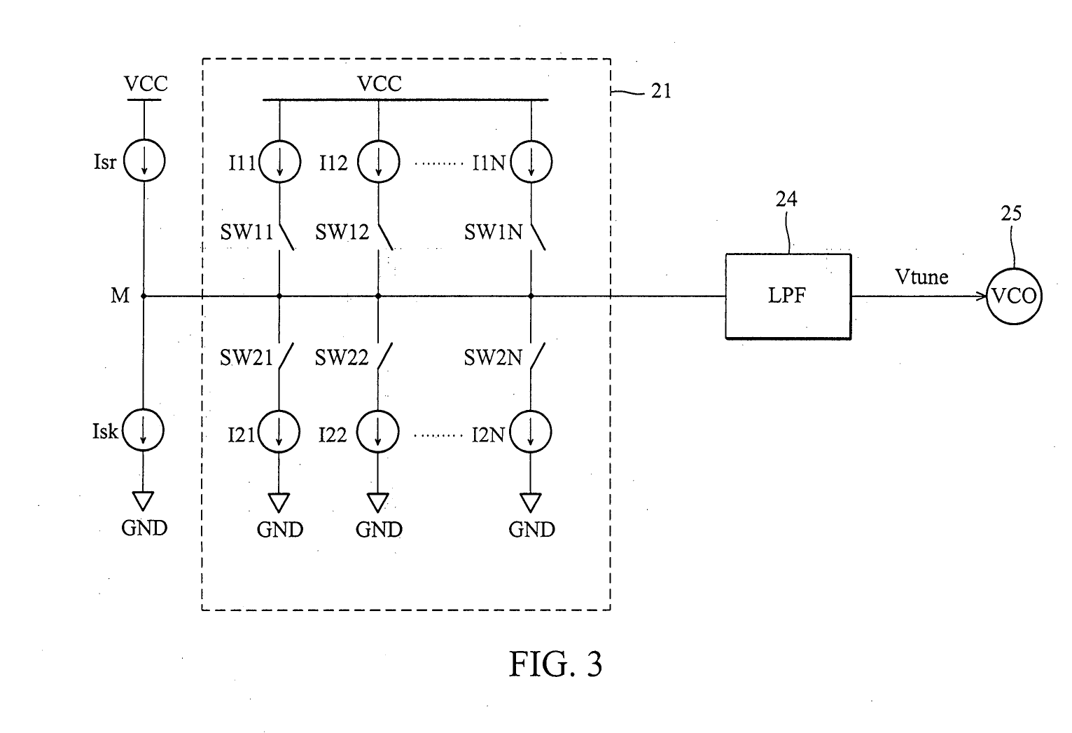

FIG. 3 is a schematic diagram of the interior of a current compensation device 21 of FIG. 2 according to the invention. In FIG. 3, the current compensation device 21 includes a plurality of first switches SW11-SW1N, a plurality of first constant current sources I11-I1N connected in series to the first switches one to one, a plurality of second switches SW21-SW2N, and a plurality of second constant current sources I21-I2N connected in series to the second switches one to one, wherein the first constant current sources respectively have an input terminal connected to the external voltage VCC, the second constant current sources respectively have a grounding output terminal, and the switches SW11-SW2N respectively have an open terminal connected to a transmission line L to form a railing implementation. One end of the transmission line L is connected to the device 25 through the filter 24 and the other is connected to the point M (FIG. 2).

As shown in FIG. 3, when the voltage Vtune input to the device 25 is higher than a first predetermined value (while the source current Isr is lower than the sink current Isk) at operation, a control signal Sc is input (described later) to close the corresponding first switches and accordingly to form current pathways such that the corresponding constant current sources flow to the transmission line L through the corresponding current pathways. The activation above starts the closing action from SW11 sequentially for sourcing the corresponding constant currents to increase the source current (or decrease the sink current) on the transmission line L, until the voltage Vtune input to the device 25 is lower than the first predetermined value (while Isr=Isk). Similarly, when the voltage Vtune input to the device 25 is lower than a second predetermined value (while the source current Isr is higher than the sink current Isk) at operation, the control signal Sc is input (described later) to close the corresponding second switches and accordingly form current pathways such that the corresponding constant current sources flow to the transmission line L through the corresponding current pathways. The activation above starts the closing action from SW21 sequentially for sinking the corresponding constant currents to decrease the sink current (or increase the sink current) flowing on the transmission line L, until the voltage Vtune input to the device 25 is higher than the second predetermined value (while Isr=Isk).

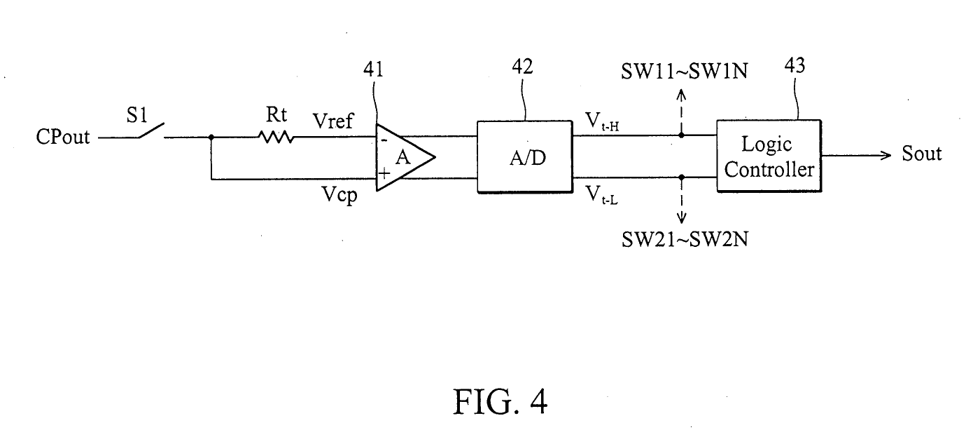

FIG. 4 is a schematic diagram of the interior of a startup compensation/setup device of FIG. 2 according to the invention. In FIG. 4, in order to provide current-calibrated compensation at startup and accordingly set the predetermined values, the startup compensation/setup device includes a detecting resistor Rt, an amplifier 41, an analog-to-digital converter 42 and a logic controller 43.

As shown in FIG. 4, the mismatch between the source and sink currents presents on two ends of the detecting resistor Rt in the form of different voltages (that is, different currents flowing to/from the resistor). Therefore, when current sources Isr, Isk are initially turned on and the switch S1 is closed, the voltages Vcp, Vref on the two ends of the detecting resistor Rt are compensated (/determined) by the amplifier 41 and the converter 42 and converted into digital reference signals V_{t-H}, V_{t-L}, input to the controller 43 to be stored. The compensation action is performed by directly input the signals V_{t-H}, V_{t-L} to the device 21 for compensation, or input an output signal Sout to the device 23 to generate the control signal Sc (described later) after the controller 43 converts the signals V_{t-H}, V_{t-L} into the output signal Sout. Further, the controller 43 can set the same or different compensation steps for current compensation in use of initialization.

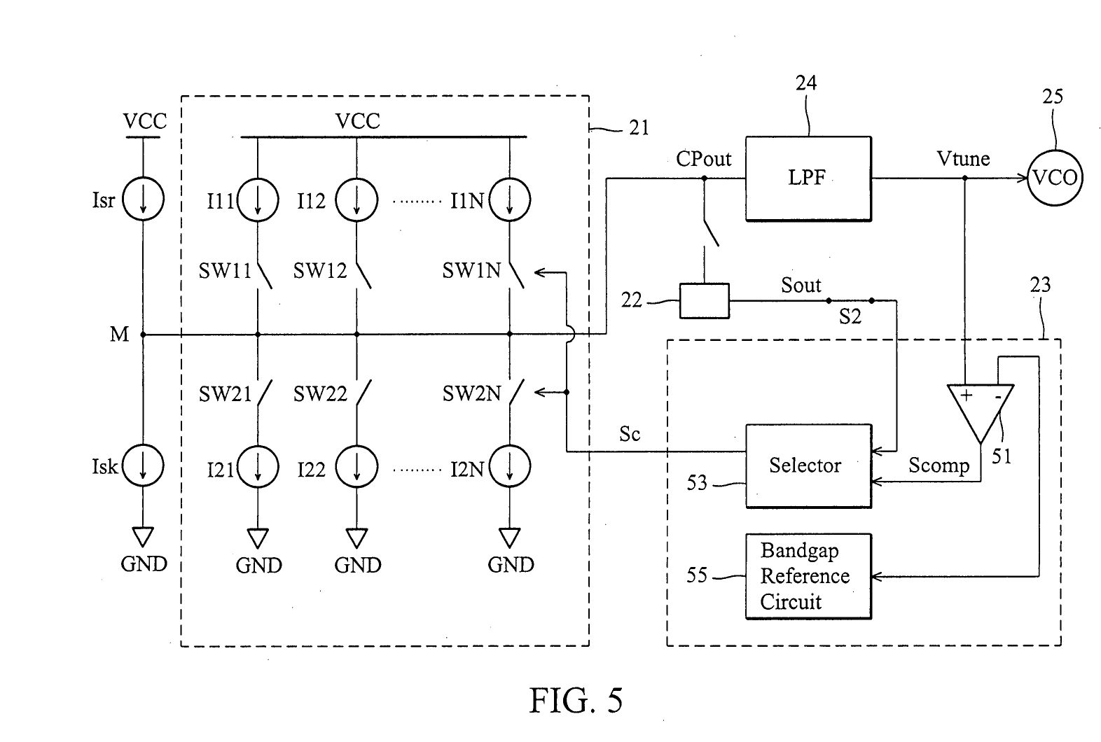

FIG. 5 is a schematic diagram of the interior of a determination device of FIG. 2 according to the invention. In FIG. 5, the determination device includes a bandgap reference circuit 55 to output a reference voltage Vt, a comparator 51 to compare the reference voltage Vt and the voltage Vtune input to the device 25 and accordingly generate a compare signal Scomp, and a selector 53 to generate the control signal Sc based on the compare signal Scomp in reference with the signal Sout output by the device 22.

As shown in FIG. 5, the signal Scomp is a differential value insufficiently determining source current or sink current and how much to compensate for the current match. Therefore, the table in the device 22 is provided with required references for current compensation. For example, in the device 21 for N=8, the signal Sout presents logic 0001 representing closing the switch SW11 for source current compensation, 0010 representing closing the switches SW11 and SW12 for source current compensation, 0011 representing closing the switches SW11, SW12 and SW13 for source current compensation, and so on. As well, the signal Sout presents logic 1001 representing closing the switch SW21 for sink current compensation, 1010 representing closing the switches SW21 and SW22 for sink current compensation, 1011 representing closing the switches SW21, SW22 and SW23 for sink current compensation, and so on. In addition, the cited logical values can be converted by a digital-to-analog converter into stepped references (or implementing the digital-to-analog converter in the controller of the device 22 to be output directly as the signal Sout). For example, logic 0001 represents a 0.001V to 1.0V output voltage, 0010 for a 1.1V to 2.0V output voltage, 0011 for a 2.1V to 3.0V output voltage, 1001 for a 0.001V to −1.0V output voltage, 1010 for a −1.1V to −2.0V output voltage, 1011 for −2.1V to −3.0V output voltage, and so on. As cited, the invention achieves the purpose of source and sink current match.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An automatic adjustment system for source current and sink current mismatch, comprising:
a startup compensation/setup device, to perform initialization current compensation and accordingly implement a control reference table;
a determination device, connected to the startup compensation/setup device through a second switch, to output a control signal according to the control reference table; and
a current compensation device, connected to the startup compensation/setup device through a first switch and to the determination device, to switch corresponding internal switches on and off according to the control signal and complete the desired compensation when the source current is the same as the sink current.

2. The automatic adjustment system according to claim 1, wherein the first switch has a closed state during the initialization current compensation and an opened state after the initialization current compensation completed.

3. The automatic adjustment system according to claim 1, further comprising:
a transmission line, connecting the current compensation device to the startup compensation/setup device;
a series of at least one first constant current source and at least one third switche, one end of the series connected to the transmission line and the other end connected to a positive voltage source;
a series of at least one second constant current source and at least one fourth switche, one end of the series connected to the transmission line and the other end connected to a ground voltage.

4. The automatic adjustment system according to claim 1, wherein the startup compensation/setup device comprises a detecting resistor, an amplifier with negative terminal connected to the detecting resistor, an analog-to-digital converter connected in series to the amplifier, and a logic controller connected in series to the analog-to-digital converter.

5. The automatic adjustment system according to claim 1, wherein the determination device consists of a bandgap reference circuit, a comparator with negative terminal connected to the bandgap reference circuit, and a selector with two input terminals respectively connected to the comparator and the second switch and output terminal connected to the current compensation device.

6. An automatic adjustment system for source current and sink current mismatch, comprising:
a first compensation unit, having multiple circuits, each consisting of a first constant current source and a first compensation switch in which, for source current compensation, an input of the first constant current source is connected to a positive voltage source and an open terminal of the first compensation switch is connected to a transmission line;
a second compensation unit, having multiple circuits, each consisting of a second constant current source and a second compensation switch in which, for sink current compensation, an output of the second constant current source is connected to a ground voltage and an open terminal of the second compensation switch is connected to the transmission line, wherein the first and second compensation units form a railing configuration;
a first switch, having a joint terminal connected to the transmission line and an open terminal to be connected to the joint terminal to form a pathway when initialized and to be disconnected to the joint terminal to form an open circuit after initialization;
a detecting resistor, connected to the open terminal of the first switch, to detect source current and sink current mismatch;
an amplifier, having a positive input terminal, a negative input terminal, a first output terminal and a second output terminal, the positive input terminal connected to the open terminal of the first switch, the negative input terminal connected to a free end of the detecting resistor to compare current difference between two ends of the detecting resistor, wherein the largest and smallest differences are respectively output through the first and second output terminals;
an analog-to-digital converter, connected to the first and second output terminals of the amplifier, to convert the largest and smallest differences from analog to digital;
a logic controller, connected to the analog-to-digital converter, to set up a control reference table according to the largest and smallest differences for required current compensation reference;
a second switch, having an open terminal and a joint terminal connected to the logic controller; and
a selector, connected to the open terminal of the second switch, to output a control signal according to the control reference table and a comparison value after the second switch is closed such that one or more circuits in the first or second compensation unit are turned on, thereby automatically performing current compensation to produce source current and sink current matching.

7. The automatic adjustment system according to claim 6, further comprising a low pass filter, connected to the transmission line and the joint terminal of the first switch, to filter unwanted signals and thus generate an output voltage.

8. The automatic adjustment system according to claim 7, wherein the selector further comprises a comparator, connected to the low pass filter, to receive the output voltage from the low pass filter, compare it to a reference voltage from an external bandgap reference circuit, and generate the comparison value.
